(19) United States
(12) Patent Application Publication
(10) Pub. No.: US 2018/0365594 A1
(43) Pub. Date: Dec. 20, 2018

(54) SYSTEMS AND METHODS FOR GENERATIVE LEARNING

(71) Applicants: William G. MACREADY, West Vancouver (CA); Fabian Ariel CHUDAK, Vancouver (CA); Zhengbing BIAN, Burnaby (CA)

(72) Inventors: William G. MACREADY, West Vancouver (CA); Fabian Ariel CHUDAK, Vancouver (CA); Zhengbing BIAN, Burnaby (CA)

(21) Appl. No.: 16/060,373

(22) PCT Filed: Jan. 27, 2017
(86) PCT No.: PCT/US2017/015401

§ 371 Date: Jun. 7, 2018

Related U.S. Application Data
(60) Provisional application No. 62/288,959, filed on Jan. 29, 2016.

(51) Int. Cl. G06N 99/00; G06N 5/04

(52) U.S. Cl. CPC G06N 99/005; G06N 99/002; G06N 5/04

(57) ABSTRACT

Generative learning by computational systems can be achieved by: forming a generative learning model comprising a constraint satisfaction problem (CSP) defined over Boolean-valued variables; describing the CSP in first-order logic which is ground to propositional satisfiability; translating the CSP to clausal form; and performing inference with at least one satisfiability (SAT) solver. A generative learning model can be formed, for example by performing perceptual recognition of a string comprising a plurality of characters, determining whether the string is syntactically valid according to a grammar, and determining whether the string is denotationally valid. Various types of processors and/or circuitry can implement such.

### BACKGROUND

### Field

This disclosure generally relates to systems, devices, methods, and articles for generative learning, and, in particular, to generative learning of the Boolean arithmetic domain.

### Generative Learning

Generative learning and discriminative learning are two categories of approaches to machine learning. Generative approaches are based on models for a joint probability distribution over the observed and the target variables, whereas discriminative approaches are based on models for a conditional probability of the target variables given the observed variables.

Examples of generative models include Restricted Boltzmann Machines, Gaussian mixture models, and probabilistic context-free grammars.

### Probabilistic Context-Free Grammars

A context-free grammar is a grammar in which each rule maps a respective single nonterminal symbol to a string of terminal and/or nonterminal symbols, and each rule can be applied regardless of the context of the respective single nonterminal symbol. In other words, the respective single nonterminal symbol can be replaced by the string of terminal and/or nonterminal symbols everywhere it occurs, without regard to context.

In a probabilistic context-free grammar, each rule is assigned a probability. The probability of a parse is the product of the probability of the rules used in the parse. The probabilities are typically determined using machine learning techniques operating on large databases.

### BRIEF SUMMARY

A method for generative learning by a computational system, the computational system comprising at least one processor and at least one nontransitory processor-readable storage medium that stores at least one of processor-executable instructions or data which, when executed by the at least one processor, cause the at least one processor to execute the method, may be summarized as including forming, by the at least one processor, a generative learning model comprising a constraint satisfaction problem (CSP) defined over Boolean-valued variables; describing, by the at least one processor, the CSP in first-order logic which is ground to propositional satisfiability; translating, by the at least one processor, the CSP to clausal form; and performing inference with at least one satisfiability (SAT) solver. Forming a generative learning model may include forming a generative learning model by performing perceptual recognition of a string comprising a plurality of characters, determining whether the string is syntactically valid according to a grammar, and determining whether the string is denotationally valid.

Determining whether the string is syntactically valid according to a grammar, and determining whether the string is denotationally valid may include determining whether an expression formed from a plurality of characters is syntactically valid according to a grammar, and determining whether the expression is denotationally valid. Determining whether an expression formed from a plurality of characters is syntactically valid according to a grammar, and determining whether the expression is denotationally valid may include determining whether an equation formed from a plurality of characters is syntactically valid according to a grammar, and determining whether the equation is denotationally valid.

Performing inference with at least one SAT solver may include performing inference with at least one SAT solver by a digital processor. Performing inference with at least one SAT solver may include performing inference with at least one SAT solver by a quantum processor. Performing inference with at least one SAT solver may include performing inference with at least one SAT solver by a digital processor and a quantum processor. In various of the above embodiments, performing inference with at least one SAT solver may include determining if there exists an interpretation satisfying a given Boolean expression. Determining if there exists an interpretation satisfying a given Boolean expression may include assigning weights and generating a probabilistic description trained using maximum likelihood methods.

A generative learning system may be summarized as including a perceptual input subsystem operable to receive a plurality of characters; compositionality logical circuitry communicatively coupled to the perceptual input subsystem, and operable to determine whether an expression involving the plurality of characters is a syntactically valid sentence in a grammar; and a denotation and semantics subsystem communicatively coupled to the compositionality logical circuitry, and operable to determine whether the expression is denotationally valid. The grammar may be a context-free grammar. In various of the above implementations, the generative learning system may be operable to perform generative learning of the Boolean arithmetic domain. The denotation and semantics subsystem may be operable to determine whether a Boolean expression is true or false. The generative learning system may include at least one SAT solver. The at least one SAT solver may be executable on a digital processor. The at least one SAT solver may be executable on a quantum processor. The at least one SAT solver may be executable on a digital processor and a quantum processor. In various of the above implementations, performing inference with the at least one SAT solver includes determining if there exists an interpretation satisfying a given Boolean expression.

In various of the above implementations and embodiments, the generative learning system may further include a hybrid computing system comprising at least one digital processor and at least one quantum processor.

A computational system may be summarized as including at least one processor, and at least one nontransitory processor-readable storage medium that stores at least one of processor-executable instructions or data which, when executed by the at least one processor, forms, by the at least one processor, a generative learning model comprising a constraint satisfaction problem (CSP) defined over Boolean-valued variables, describes, by the at least one processor, the CSP in first-order logic which is ground to propositional satisfiability, translates, by the at least one processor, the CSP to clausal form, and performs inference with at least one satisfiability (SAT) solver.

### BRIEF DESCRIPTION OF THE SEVERAL VIEWS OF THE DRAWING(S)

In the drawings, identical reference numbers identify similar elements or acts. The sizes and relative positions of elements in the drawings are not necessarily drawn to scale. For example, the shapes of various elements and angles are not necessarily drawn to scale, and some of these elements are arbitrarily enlarged and positioned to improve drawing legibility. Further, the particular shapes of the elements as drawn are not necessarily intended to convey any information regarding the actual shape of the particular elements, and have been selected for ease of recognition in the drawings.

FIG. 1 is a block diagram of a generative learning system in accordance with the present systems, devices, articles, and methods, according to at least one implementation.

FIG. 2 is a flow chart illustrating a method of generative learning in accordance with the present systems, devices, articles, and methods, according to at least one implementation.

FIG. 3 is a schematic diagram illustrating an example character in accordance with the present systems, devices, articles, and methods.

FIG. 4 is a schematic diagram illustrating an example set of terminal characters in accordance with the present systems, devices, articles, and methods.

FIG. 5 is a schematic diagram of an example valid binary arithmetic expression in accordance with the present systems, devices, articles, and methods.

FIG. 6 is a schematic diagram of an example invalid binary arithmetic expression in accordance with the present systems, devices, articles, and methods.

FIG. 7 is a schematic diagram of the valid binary arithmetic expression of FIG. 5 comprising characters with occluded pixels in accordance with the present systems, devices, articles, and methods.

FIG. 8 is a schematic diagram of another example valid binary arithmetic expression comprising a product of binary variables in accordance with the present systems, devices, articles, and methods.

FIG. 9 is a schematic diagram of the valid binary arithmetic expression of FIG. 5 in which the representation of characters is inferred in accordance with the present systems, devices, articles, and methods.

FIG. 10 is a block diagram of a hybrid computing system in accordance with the present systems, devices, articles, and methods, according to at least one implementation.

### DETAILED DESCRIPTION

### General Comments

In the following description, some specific details are included to provide a thorough understanding of various disclosed embodiments. One skilled in the relevant art, however, will recognize that embodiments may be practiced without one or more of these specific details, or with other methods, components, materials, etc. In other instances, well-known structures associated with quantum processors, such as quantum devices, couplers, and control systems including microprocessors and drive circuitry have not been shown or described in detail to avoid unnecessarily obscuring descriptions of the embodiments of the present methods. Throughout this specification and the appended claims, the words “element” and “elements” are used to encompass, but are not limited to, all such structures, systems, and devices associated with quantum processors, as well as their related programmable parameters.

Unless the context requires otherwise, throughout the specification and claims which follow, the word “comprise” and variations thereof, such as, “comprises” and “comprising” are to be construed in an open, inclusive sense, that is as “including, but not limited to.”

Reference throughout this specification to “one embodiment” “an embodiment”, “another embodiment”, “one example”, “an example”, “another example”, “one implementation”, “another implementation”, or the like means that a particular referent feature, structure, or characteristic described in connection with the embodiment, example, or implementation is included in at least one embodiment, example, or implementation. Thus, the appearances of the phrases “in one embodiment”, “in an embodiment”, “another embodiment” or the like in various places throughout this specification are not necessarily all referring to the same embodiment, example, or implementation. Furthermore, the particular features, structures, or characteristics may be combined in any suitable manner in one or more embodiments, examples, or implementations.

It should be noted that, as used in this specification and the appended claims, the singular forms “a,” “an,” and “the” include plural referents unless the content clearly dictates otherwise. Thus, for example, reference to a problem-solving system including “a quantum processor” includes a single quantum processor, or two or more quantum processors. It should also be noted that the term “or” is generally employed in its sense including “and/or” unless the content clearly dictates otherwise.

The headings provided herein are for convenience only and do not interpret the scope or meaning of the embodiments.

### Introduction

A shortcoming of common approaches to machine learning is that the system usually needs to be learned de novo, that is, starting from the beginning. Common approaches typically have little or no domain knowledge as part of the generative model. The present systems and methods address the shortcomings of common approaches by including multiple aspects of the generative learning domain, by blending stochastic and logical inference, and by engineering domain knowledge into the generative model.

### Generative Learning Systems and Methods

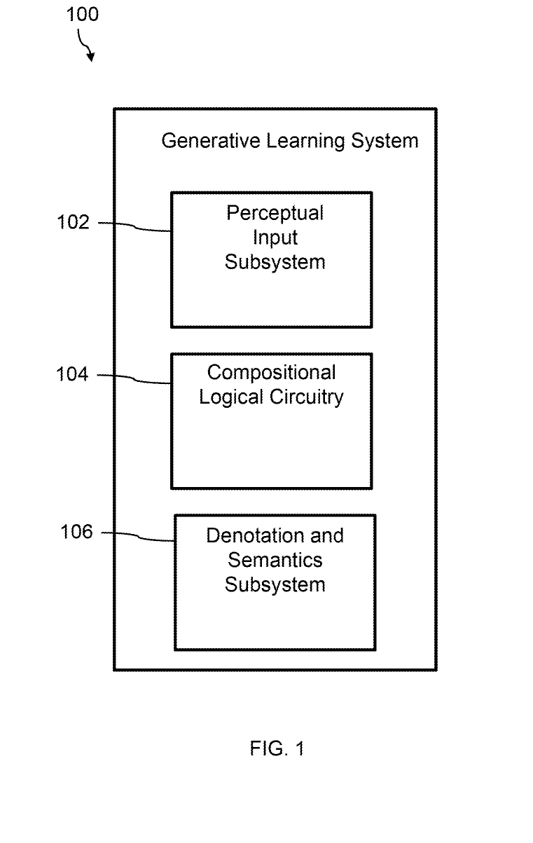

FIG. 1 is a block diagram of a generative learning system 100 in accordance with the present systems, devices, articles, and methods, according to at least one implementation. Generative learning system 100 can be built using a generative model that encompasses more than one aspect of the generative learning domain. For example, generative learning system 100 can include percepts, compositional structure, denotation and semantics. Compositional structure can be expressed as a grammar such as a context-free grammar.

Generative learning system 100 comprises a perceptual input subsystem 102, compositionality logical circuitry 104, and a denotation and semantics subsystem 106. Generative learning system 100 can be used for generative learning of the Boolean arithmetic domain, for example.

Perceptual input subsystem 102 can comprise at least one processor, and at least one processor-readable medium that stores at least one of processor-executable instructions and data, which in operation can perform perceptual input tasks such as receiving a plurality of characters input to generative learning system 100.

The plurality of characters input to generative learning system 100 can be a string of characters. In some instances, the string can be an expression, for example if it contains at least one operator. The expression may be a Boolean expression, for example. In some instances, the expression can be an equation, for example if at least one of the operators is an “=” operator. The equation may be an arithmetic binary equation, for example.

Perceptual input subsystem 102 can include a statistical recognizer for characters. In an implementation in the Boolean arithmetic domain, perceptual input subsystem 102 can include a statistical recognizer for terminal characters “0”, “1”, “+”, “×”, and “=”. Each character can be expressed as an array of binary or gray-scale values or pixels, such as in the MNIST (Mixed National Institute of Standards and Technology) database. The MNIST database is a large database of handwritten characters used to train and test image processing systems and machine learning systems, for example.

Compositionality logical circuitry 104 can include logical circuitry for determining whether an expression involving the terminal characters is a valid sentence in a grammar such as a context-free grammar (CFG) or a near context-free grammar. In some implementations, compositionality logical circuitry 104 can determine whether an expression involving the terminal characters “0”, “1”, “+”, “×”, and “=” is a valid sentence in a CFG for expressions of binary arithmetic.

Denotation and semantics subsystem 106 can comprise at least one processor, and at least one processor-readable medium that stores at least one of processor-executable instructions and data, which in operation can perform denotation and semantics tasks such as determining whether an expression formed from at least some of the characters input to generative learning system 100 is denotationally valid. In some implementations, denotation and semantics subsystem 106 can check whether the left-hand and right-hand sides of an arithmetic binary equation are equal, i.e., whether a Boolean expression is true or false.

In some implementations, generative learning system 100 can be built on a generative learning model that is a constraint satisfaction problem (CSP) defined over Boolean-valued variables. The CSP can be described in first-order logic which is ground to propositional satisfiability and then translated to clausal form so that inference can be performed with SAT (SATISFIABILITY) solvers. SAT is the problem of determining if there exists an interpretation satisfying a given Boolean expression. The model can include weighted satisfiability to allow for a probabilistic description trained using maximum likelihood methods.

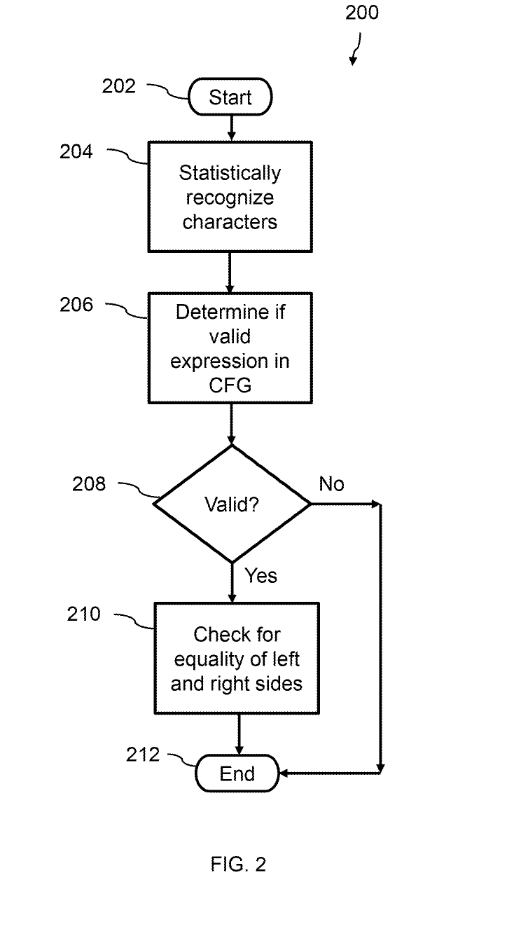

FIG. 2 is a flow chart illustrating a method 200 of generative learning in accordance with the present systems, devices, articles, and methods, according to at least one implementation. Method 200 includes acts 202 to 212, though those skilled in the art will appreciate that in alternative embodiments certain acts may be omitted and/or additional acts may be added. Those skilled in the art will appreciate that the order of the acts is shown for exemplary purposes only and may change in alternative embodiments.

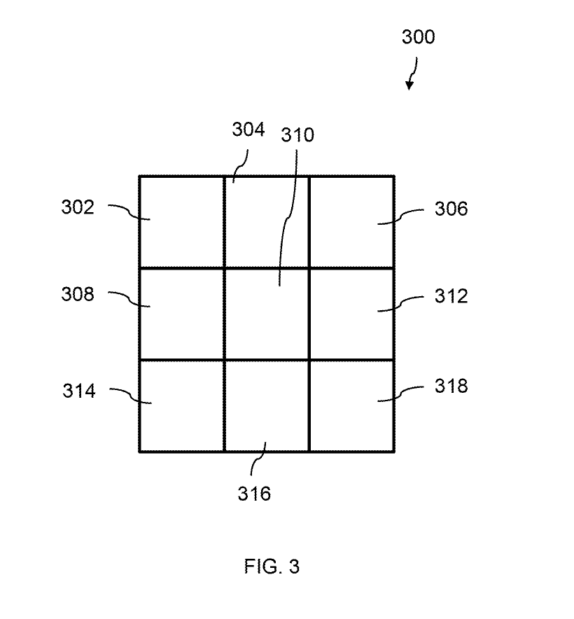

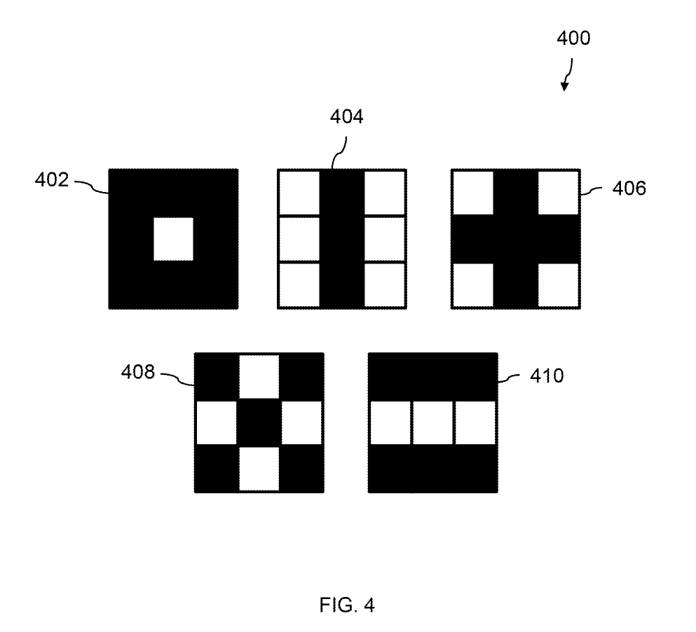

Method 200 starts at 202, for example in response to a user request or an invocation from another method. At 204, one or more hardware components (e.g., one or more digital and/or quantum processors, one or more digital and/or analog circuits, one or more nontransitory storage media) executing the method 200 performs statistical recognition of one or more input characters. The statistical recognition of input characters is described in more detail below with reference to FIGS. 3 and 4.

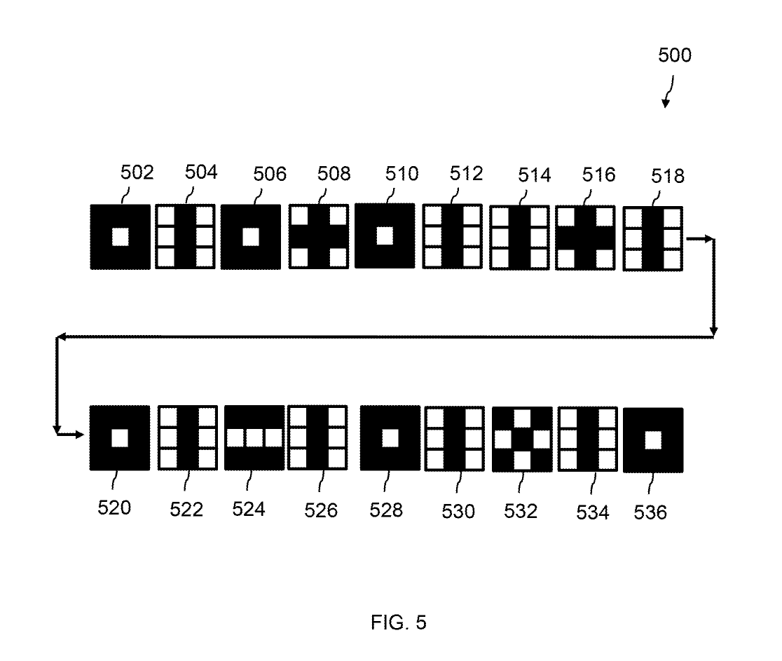

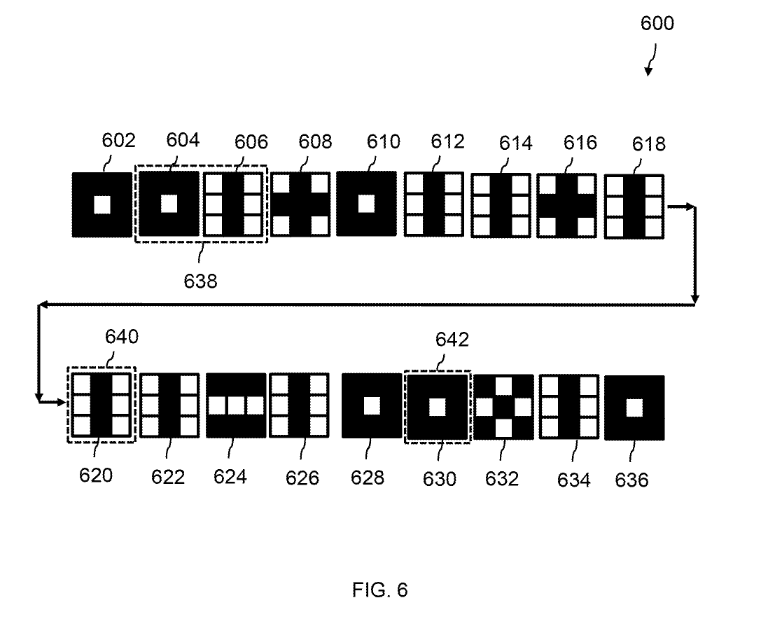

At 206, one or more hardware components executing the method 200 determines if an expression defined by the one or more input characters recognized in 204 is a valid expression in a CFG. More detail is provided below with reference to FIGS. 5 and 6.

At 208, one or more hardware components executing the method 200 determines if the expression is a valid expression in the CFG. Upon determining the expression is valid, method 200 proceeds to 210 where method 200 checks for equality of the left-hand and right-hand sides of the expression. At 212, method 200 ends.

At 208, upon determining the expression is invalid, method 200 proceeds to 212 where method 200 ends.

The input can be expressed as an array of K pixel images representing relevant symbols, in this case binary digits and mathematical operators for combining sequences of binary digits. The input characters can be the terminal characters “0”, “1”, “+”, “×”, and “=”. Method 200 can leverage existing generative neural network approaches (such as Restricted Boltzmann Machines) which can be trained to translate from image patterns corresponding to the symbols to Boolean-valued indicators of each variable.

Assuming binary-valued image patterns, the k^{th} pattern of pixels can be described with the variable Image[k, i, j] where Image[k, i, j]=0 indicates the pixel at (i, j) is “off” and Image[k, i, j]=1 indicates the pixel is “on”.

The variable 1≤k≤K indexes the images, and the variables 1≤i, j≤N index the pixels with an N×N array of pixel values. The variables indicate that the k^{th} input is interpreted by the neural network as Input[k, t]=1, where t∈{0, 1, +, X, =}. The neural network assigns negligible probability to Input[k, t′]=1 for all other choices of t′≠t. Training of the neural network defines a probability distribution P(Image; Input) where Image and Input refer collectively to all variables of the respective type. P(Input|Image) and P(Image|Input) are assumed to be tractable.

In the various implementations, the system can rely on logical constraints rather than probabilistic models. For example, when K=18 and N=3, a direct translation can be made between pixels patterns and symbols. The pixel representation can be converted to an input symbol so that Input[k, 0] is true if, and only if, all nine pixel patterns match the representation of 0. Every element k of the input array is assigned a symbol so that Input[k, 0]+Input[k, 1]+Input[k, +]+Input[k, ×]+Input[k, =]=1 for all k.

FIG. 3 is a schematic diagram illustrating an example character 300 in accordance with the present systems, devices, articles, and methods. Character 300 comprises a 3×3 array of nine values or pixels 302, 304, 306, 308, 310, 312, 314, 316, and 318. Each of the nine pixels can comprise a binary or gray-scale value.

FIG. 4 is a schematic diagram illustrating an example set of terminal characters 400 in accordance with the present systems, devices, articles, and methods. Set of terminal characters 400 comprises five characters 402, 404, 406, 408, and 410. Each character in set of characters 400 comprises an array of nine pixels such as character 300 of FIG. 3. Each pixel in each of characters 402, 404, 406, 408, and 410 can comprise a value of either one (“on”) or zero (“off”), or, equivalently for the purposes of illustration, solid black or white, respectively.

Character 402 can represent a “0” character. Character 404 can represent a “1” character. Character 406 can represent a “+” character. Character 408 can represent a “×” character. Character 410 can represent a “=” character.

Expressions can be, for example, limited to K symbols where each symbol is selected from the group of terminal characters consisting of 0, 1, +, ×, =. Valid compositions of the symbols are described with a grammar capturing standard notions of arithmetic Boolean expressions. For example, the Boolean expression “00++1==×0” is syntactically invalid. In another example, Boolean expression “01+10=00” is syntactically correct but denotationally incorrect, while “01+10=11” is both syntactically and denotationally valid. The validity of the Boolean expressions can be based on the tokenized inputs encoded in the variables Input[k, t] which can, in turn, be defined from perceptual inputs Image[k, i, j].

A standard approach to describing valid and invalid compositions is through context-free grammars. The compositional structure recognized by the grammar can be converted to a form that can subsequently be evaluated, for example, by logical circuitry able to implement addition and multiplication operations, and able to determine whether two sides of an equation are equal, to define the denotation of the parse.

A variety of alternative formalisms can be used to parse the inputs. One approach encodes a standard context-free grammar consisting of productions in a standard format such as a Chomsky normal form. A Cocke-Younger-Kasami (CYK) parser for the context-free grammar can be represented with logical variables, and contiguous intervals of an input string can be mapped to particular production symbols. An input is valid if the entire input from all k pixel images can be mapped to an accepted symbol of the grammar.

The grammar can route input symbols to appropriate logical circuitry to obtain a denotation of the input. Certain production symbols can indicate addition/multiplication/equality operations, and can correspond to nodes in the parse tree. The denotation of the entire parse tree can be captured by additional variables Node[n, w] indexed by nodes in the parse tree n, and bit positions w that capture the output bit string from a node in the parse tree. For example, a node n representing an addition operation can be captured with the constraint add(Node[n₁; :]; Node[n₂; :]; Node[n; :]) where n₁ and n₂ label the children of node n in the parse tree.

Alternative approaches such Combinatory Categorical Grammars can be used in a similar fashion, and offer an enlarged scope of grammars that can be parsed efficiently.

It is generally known that arithmetic on Boolean values can be realized with logical circuits. It can be convenient to work with AND, OR, XOR, NOT, half-adder and full-adder constraints. Standard combinatorial constructions can be used to build up addition, multiplication, and equality circuits. These circuits can be made undirected (where the inputs can be inferred from the outputs) by encoding each elemental gate as a propositional constraint. The generative model can assume a library of available addition and multiplication circuits indexed by 1≤k≤K. While somewhat redundant, it can be convenient to index arithmetic circuits by k since an arithmetic Boolean expression of at most K symbols will never have more than K addition or multiplication operations.

For example, the system can assume a fixed maximal bit width W for both the input and output of each arithmetic circuit. The constraints add(k, in[1, 1], . . . , in[1, W], in[2, 1], . . . , in[2; W], out[1], . . . , out[W]) and mult(k, in[1, 1], . . . , in[1, W], in[2, 1], . . . , in[2, W], out[1]) are true/false if, and only if, the two input bit strings in[1, :] and in[2, :] add/multiply to the output bitstring out[:]. In some cases, high bits can be set explicitly to “0” (zero).

FIG. 5 is a schematic diagram of an example valid binary arithmetic expression 500 in accordance with the present systems, devices, articles, and methods. Binary arithmetic expression 500 comprises eighteen characters 502, 504, 506, 508, 510, 512, 514, 516, 518, 520, 522, 524, 526, 528, 530, 532, 534, and 536. Each character comprises a 3×3 array of nine pixels such as character 300 of FIG. 3. Each of eighteen characters 502 through 536 can comprise a character from set of characters 400 of FIG. 4. For example, character 502 represents a “0” character, character 504 represents a “1” character, character 508 represents a “+” character, and character 532 represents a “×” character.

FIG. 6 is a schematic diagram of an example invalid binary arithmetic expression 600 in accordance with the present systems, devices, articles, and methods. Binary arithmetic expression 600 comprises eighteen characters 602, 604, 606, 608, 610, 612, 614, 616, 618, 620, 622, 624, 626, 628, 630, 632, 634, and 636. Each character comprises a 3×3 array of nine pixels such as character 300 of FIG. 3. Each of eighteen characters 602 through 636 can comprise a character from set of characters 400 of FIG. 4. For example, character 602 represents a “0” character, character 606 represents a “1” character, character 608 represents a “+” character, and character 632 represents a “×” character. Binary arithmetic expression 600 differs from binary arithmetic expression 500 in four characters, as indicated by the dashed boxes 638, 640, and 642. The changes to expression 500 cause expression 600 to become an invalid expression.

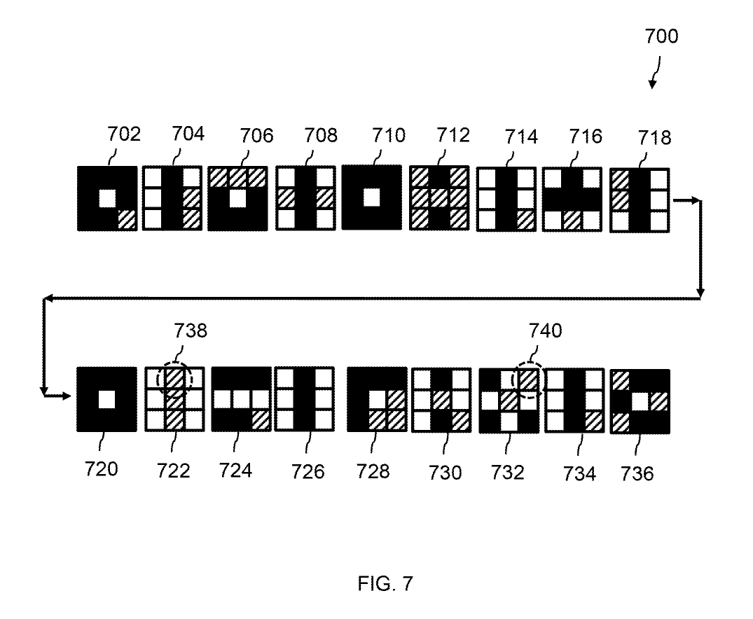

FIG. 7 is a schematic diagram of a valid binary arithmetic expression 700, which is the valid binary arithmetic expression 500 of FIG. 5 comprising characters with occluded pixels in accordance with the present systems, devices, articles, and methods. Binary arithmetic expression 700 comprises eighteen characters 702, 704, 706, 708, 710, 712, 714, 716, 718, 720, 722, 724, 726, 728, 730, 732, 734, and 736. Each character comprises a 3×3 array of nine pixels such as character 300 of FIG. 3. Each of eighteen characters 702 through 736 can comprise a character from set of characters 400 of FIG. 4.

A generative description of a domain can capture an understanding of the domain so that inferences may be made with a limited amount of supplied information. For example, the values of some pixels can be provided as input, and other pixel values inferred. FIG. 7 illustrates a case where some of the pixels are occluded. The occluded pixels are indicated in FIG. 7 by pixels with diagonal patterning, such as pixels 738 and 740 highlighted by a dashed circle. The present systems and methods for generative learning can infer values for the occluded pixels based on the understanding of the domain and the incomplete pixel images provided.

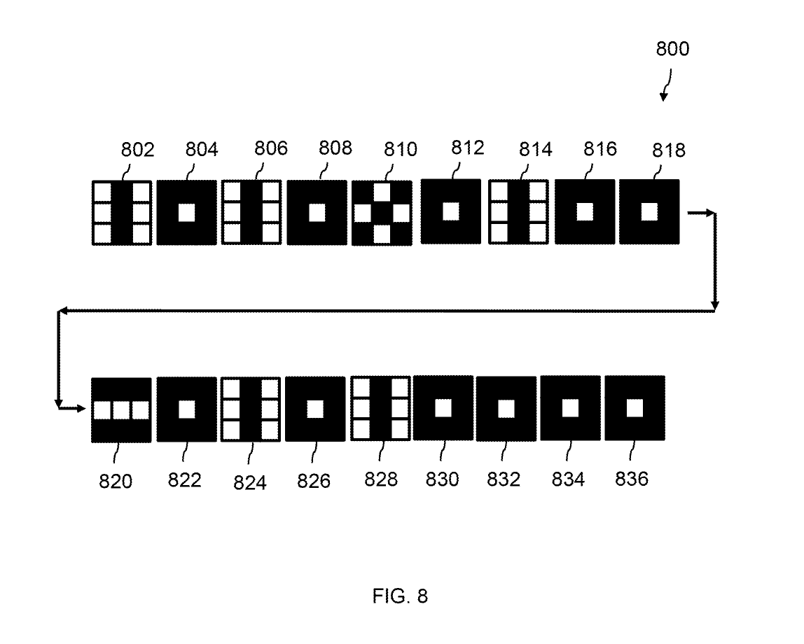

FIG. 8 is a schematic diagram of another example valid binary arithmetic expression 800 comprising a product of binary variables in accordance with the present systems, devices, articles, and methods. The present systems and methods for generative learning can solve for multiple unknowns. For example, given an expression comprising a product of two factors, and assuming the product is known, the present systems and methods can infer the two factors.

Binary arithmetic expression 800 comprises eighteen characters 802 through 836. A first factor is represented by characters 802, 804, 806, and 808. The first factor in the example of FIG. 8 is “1010”. Character 810 represents a “×” character. A second factor is represented by characters 812, 814, 816, and 818. The second factor in the example of FIG. 8 is “0100”. Character 820 represents a “=” character. The product of the first and the second factors is represented by characters 822, 824, 826, 828, 830, 832, 834, and 836. The product in the example of FIG. 8 is “01010000”. The equivalent decimal expression is 10×8=80. Generative learning methods such as those described with reference to FIGS. 1 and 2 can be used to infer the first and the second factors from the characters, and from knowledge of the product.

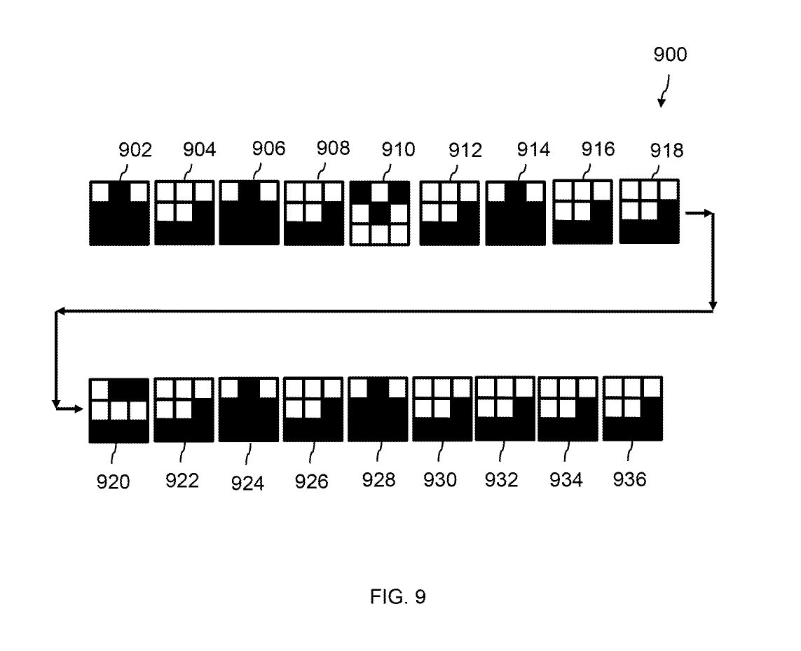

FIG. 9 is a schematic diagram of a valid binary arithmetic expression 900, which is the valid binary arithmetic expression 500 of FIG. 5 in which the representation of characters is inferred in accordance with the present systems, devices, articles, and methods. Binary arithmetic expression 900 comprises eighteen characters 902, 904, 906, 908, 910, 912, 914, 916, 918, 920, 922, 924, 926, 928, 930, 932, 934, and 936. Each character comprises a 3×3 array of nine pixels such as character 300 of FIG. 3. Each of eighteen characters 902 through 936 can comprise a character from set of characters 400 of FIG. 4. A generative description of a domain can capture an understanding of the domain so that inferences may be made with a limited amount of supplied information. For example, the values of some pixels can be provided as input and other pixel values inferred.

The present systems and methods for generative learning can solve for the unknown elements of the expression. A generative model comprising an encoding of partial domain knowledge can result in faster learning of unknown aspects of the domain. For example, given training samples of binary arithmetic in a language in which the pixel representations of the terminal characters are unknown, the system can infer the representations more rapidly by knowing the larger compositional and denotational context constraining connecting pixel representations.

The representations can be then be learned with fewer training examples. Similarly, other constraints can be relaxed. For example, the legal compositions can be generated by an unknown grammar, and the grammar inferred from training data. More generally, human knowledge can be encoded as logical constraints and used in conjunction with standard statistical inference to perform learning with less prior knowledge, or to learn in more complex domains.

### Applications

One specific exemplary application of the present systems and methods for generative learning is code inpainting. Inpainting is usually associated with images and videos, and refers to the process of reconstructing lost or damaged areas of images and videos. Inpainting can be generalized to refer to providing or correcting areas of other forms of information such as computer software source code.

In the example of code inpainting, the system can be provided with pixel images representing an incomplete specification of a source code module. A statistical recognizer can be used to identify symbols corresponding to pixel images. A CFG can be defined, and logical circuitry used to determine whether expressions in the code are syntactically and denotationally valid. The system can perform inpainting of the code to add and correct code in accordance with the results.

### Generative Learning Using a Computational System

The present systems and methods for generative learning can be implemented in a computational system comprising at least one processor. The at least one processor can, for example, take the form of one or more digital processors. Alternatively, the at least one processor can take the form of one or more quantum processors. In yet another example, the computational system is a hybrid computing system comprising at one or more digital processors and one or more quantum processors.

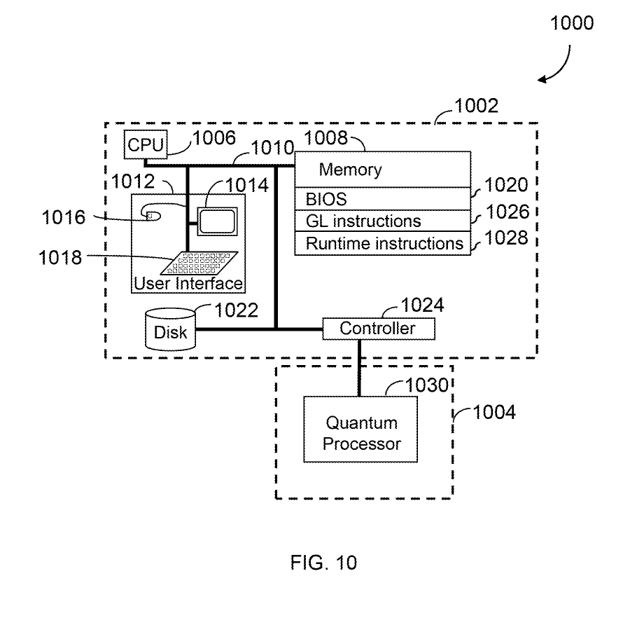

FIG. 10 is a block diagram of a hybrid computing system 1000 in accordance with the present systems, devices, articles, and methods, according to at least one implementation. Hybrid computing system 1000 comprises a digital computer 1002 coupled to an analog computer 1004. In some implementations, analog computer 1004 is a quantum computer and digital computer 1002 is a classical computer. The exemplary digital computer 1002 includes a digital processor (CPU) 1006 that may be used to perform classical digital processing tasks described in the present systems and methods.

Digital computer 1002 may include at least one system memory 1008, and at least one system bus 1010 that couples various system components, including system memory 1008 to central processor unit 1006.

The digital processor may be any logic processing unit, such as one or more central processing units (“CPUs”), graphics processing units (“GPUs”), digital signal processors (“DSPs”), application-specific integrated circuits (“ASICs”), field-programmable gate arrays (“FPGAs”), etc. Unless described otherwise, the construction and operation of the various blocks shown in FIG. 10 are of conventional design. As a result, such blocks need not be described in further detail herein, as they will be understood by those skilled in the relevant art.

Digital computer 1002 may include a user input/output subsystem 1012. In some implementations, user input/output subsystem 1012 includes one or more user input/output components such as a display 1014, mouse 1016, and/or keyboard 1018. System bus 1010 can employ any known bus structures or architectures, including a memory bus with a memory controller, a peripheral bus, and a local bus. System memory 1008 may include non-volatile memory, such as read-only memory (“ROM”), static random access memory (“SRAM”), Flash NAND; and volatile memory such as random access memory (“RAM”) (not shown), all of which are examples of nontransitory computer- or processor-readable media. An basic input/output system (“BIOS”) 1020, which can form part of the ROM, contains basic routines that help transfer information between elements within digital computer 1002, such as during startup.

Digital computer 1002 may also include other non-volatile memory 1026. Non-volatile memory 1026 may take a variety of forms, including: a hard disk drive for reading from and writing to a hard disk, an optical disk drive for reading from and writing to removable optical disks, and/or a magnetic disk drive for reading from and writing to magnetic disks, all of which are examples of nontransitory computer- or processor-readable media. The optical disk can be a CD-ROM or DVD, while the magnetic disk can be a magnetic floppy disk or diskette. Non-volatile memory 1026 may communicate with digital processor via system bus 1010 and may include appropriate interfaces or controllers 1028 coupled to system bus 1010. Non-volatile memory 1026 may serve as long-term storage for computer- or processor-readable instructions, data structures, or other data (also called program modules) for digital computer 1002.

Although digital computer 1002 has been described as employing hard disks, optical disks and/or magnetic disks, those skilled in the relevant art will appreciate that other types of non-volatile computer-readable media may be employed, such a magnetic cassettes, flash memory cards, Flash, ROMs, smart cards, etc., all of which are further examples of nontransitory computer- or processor-readable media. Those skilled in the relevant art will appreciate that some computer architectures conflate volatile memory and non-volatile memory. For example, data in volatile memory can be cached to non-volatile memory. Or a solid-state disk that employs integrated circuits to provide non-volatile memory. Some computers place data traditionally stored on disk in memory. As well, some media that are traditionally regarded as volatile can have a non-volatile form, e.g., Non-Volatile Dual In-line Memory Module variation of Dual In-Line Memory Modules.

Various sets of computer- or processor-readable instructions (also called program modules), application programs and/or data can be stored in system memory 1008.

In the various implementations, system memory 1008 may store generative learning instructions 1026. For example, generative learning instructions 1026 in system memory 1008 can implement the methods like those described in reference to FIGS. 1 through 9 on CPU 1006 and/or analog computer 1004.

In the various implementations, system memory 1008 may store runtime instructions 1028 to provide executable procedures and parameters to deploy and/or monitor generative learning methods.

While shown in FIG. 10 as being stored in system memory 1008, the instructions and/or data described above can also be stored elsewhere including in non-volatile memory 1022 or one or more other non-transitory computer- or processor-readable media.

Analog computer 1004 includes an analog processor such as a quantum processor 1030. Quantum processor 1030 can include programmable elements such as qubits, couplers, and other devices. Quantum processor 1030 can include superconducting qubits.

In various implementations, quantum processor 1030 performs quantum annealing and/or adiabatic quantum computation.

The above description of illustrated embodiments, including what is described in the Abstract, is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other analog processors, not necessarily the exemplary quantum processors generally described above.

The various embodiments described above can be combined to provide further embodiments. To the extent that they are not inconsistent with the specific teachings and definitions herein, all of the US patents, US patent application publications, US patent applications, referred to in this specification and/or listed in the Application Data Sheet, are incorporated herein by reference, including U.S. Provisional Patent Application No. 62/288,959, filed Jan. 29, 2016, in their entirety. Aspects of the embodiments can be modified, if necessary, to employ systems, circuits and concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A method for generative learning by a computational system, the computational system comprising at least one processor and at least one nontransitory processor-readable storage medium that stores at least one of processor-executable instructions or data which, when executed by the at least one processor, cause the at least one processor to execute the method, the method comprising:
forming, by the at least one processor, a generative learning model comprising a constraint satisfaction problem (CSP) defined over Boolean-valued variables;
describing, by the at least one processor, the CSP in first-order logic which is ground to propositional satisfiability;
translating, by the at least one processor, the CSP to clausal form; and
performing inference with at least one satisfiability (SAT) solver.

2. The method of claim 1 wherein forming a generative learning model includes forming a generative learning model by performing perceptual recognition of a string comprising a plurality of characters, determining whether the string is syntactically valid according to a grammar, and determining whether the string is denotationally valid.

3. The method of claim 1 wherein determining whether the string is syntactically valid according to a grammar, and determining whether the string is denotationally valid includes determining whether an expression formed from a plurality of characters is syntactically valid according to a grammar, and determining whether the expression is denotationally valid.

4. (canceled)

5. The method of claim 1 wherein performing inference with at least one SAT solver includes performing inference with at least one SAT solver by at least one of a digital processor and a quantum processor.

6. (canceled)

7. (canceled)

8. The method of claim 5 wherein performing inference with at least one SAT solver includes determining if there exists an interpretation satisfying a given Boolean expression.

9. The method of claim 8 wherein determining if there exists an interpretation satisfying a given Boolean expression includes assigning weights and generating a probabilistic description trained using maximum likelihood methods.

10. A generative learning system comprising:
a perceptual input subsystem operable to receive a plurality of characters;
compositionality logical circuitry communicatively coupled to the perceptual input subsystem, and operable to determine whether an expression formed from at least some of the plurality of characters is a syntactically valid sentence in a grammar; and
a denotation and semantics subsystem communicatively coupled to the compositionality logical circuitry, and operable to determine whether the expression is denotationally valid.

11. The generative learning system of claim 10 wherein the grammar is a context-free grammar.

12. The generative learning system of claim 10 wherein the generative learning system is operable to perform generative learning of the Boolean arithmetic domain.

13. The generative learning system of claim 12 wherein the denotation and semantics subsystem is operable to determine whether a Boolean expression is true or false.

14. The generative learning system of claim 10 wherein the generative learning system comprises at least one SAT solver.

15. The generative learning system of claim 14 wherein the at least one SAT solver is executable on at least one of a digital processor and a quantum processor.

16. (canceled)

17. (canceled)

18. The generative learning system of claim 15 wherein the at least one SAT solver is operable to determine if there exists an interpretation satisfying a given Boolean expression.

19. The generative learning system of claim 10 wherein the generative learning system further comprises a hybrid computing system comprising at least one digital processor and at least one quantum processor.

20. A computational system comprising:
at least one processor; and
at least one nontransitory processor-readable storage medium that stores at least one of processor-executable instructions or data which, when executed by the at least one processor:
forms, by the at least one processor, a generative learning model comprising a constraint satisfaction problem (CSP) defined over Boolean-valued variables;
describes, by the at least one processor, the CSP in first-order logic which is ground to propositional satisfiability;
translates, by the at least one processor, the CSP to clausal form; and
performs inference with at least one satisfiability (SAT) solver.
